(19) United States
(12) Patent Application Publication
(10) Pub. No.: US 2026/0068967 A1
(43) Pub. Date: Mar. 12, 2026

(54) HEATING SHAWL

(71) Applicant: JingWeiLianHe (Hong Kong) Technology Co., Limited, HONG KONG (HK)

(72) Inventor: XIN CHEN, HONG KONG (HK)

(21) Appl. No.: 19/208,842

(22) Filed: May 15, 2025

Related U.S. Application Data
(63) Continuation-in-part of application No. 18/828,187, filed on Sep. 9, 2024.

(51) Int. Cl. A41D 13/005; A41D 3/08; H05B 3/34

(52) U.S. Cl. CPC A41D 13/0051; A41D 3/08; H05B 3/345; A41D 2300/322; A41D 2300/324; H05B 2203/036

(57) ABSTRACT

A heating shawl includes a shawl body and a heating element arranged inside the shawl body and configured to heat the shawl body. An outer side surface of the shawl body opposite to the heating element is provided with a contact surface, the contact surface is configured to contact with a human body. The contact surface is connected to at least one heat conducting member, and the heat conducting member is configured to conduct heat. The heating shawl provided by the present disclosure can transmit heat to the human body, fit the user's body, enhance the hot compress effect, and is easy to put on and take off, providing the user with a better use experience.

### CROSS-REFERENCE TO RELATED APPLICATIONS

This application is a Continuation-in-Part of the U.S. application Ser. No. 18/828,187 filed on Sep. 9, 2024, and entitled “Heating shawl” now pending, the entire disclosures of which are incorporated herein by reference.

### TECHNICAL FIELD

The present disclosure relates to a shawl, in particular to a heating shawl.

### BACKGROUND

The heating shawl, also known as the exothermic shawl or the electric heating shawl, is specially designed for people who suffer from shoulder and neck discomfort due to long-term sedentary office work or special post work. The heating shawl is made of soft and skin-friendly material, which fits the skin and is easy to operate. Whether at home for leisure or office study, it can effectively relieve the pressure on the shoulder and neck, eliminate discomfort and bring a warm and comfortable experience.

The existing US patent No. 20140131341 discloses an “Autonomous Heated Interlining”. The self-heating interlining in this patent includes a main heating channel and a secondary heating channel for heating the interlining. However only the interior is heated, and when the shawl is used, the heat transferred to the surface of the shawl is less, the temperature is low, the heating is uneven, and the hot compress physical therapy effect is poor.

Therefore, there is a need to put forward a new type of heating shawl, which can uniformly distribute heat on the whole shawl, enhance the heating effect of shawl, promote blood circulation and effectively relieve muscle fatigue and soreness.

### SUMMARY

The present disclosure provides a heating shawl to solve the problem that the heating shawl proposed in the above background can not uniformly distribute heat.

In order to solve the above problems, the present disclosure adopts the following technical solution.

The present disclosure provides a heating shawl, which includes a shawl body and a heating element.

The heating element is arranged inside the shawl body and configured to heat the shawl body; an outer side surface of the shawl body opposite to the heating element includes a contact surface configured to contact with a human body; at least one heat conducting member is connected to the contact surface and configured to conduct heat.

Furthermore, the heat conducting member includes a plurality of heat conducting strips, the plurality of the heat conducting strips are arranged at intervals; or at least a portion of the heat conducting strips are crossed with each other to form a heat conducting mesh to spread the heat evenly.

Furthermore, a shape of the heat conducting mesh is hexagonal.

Furthermore, the heat conducting member is printed on the contact surface.

Furthermore, the heat conducting member is yarn, connecting to the contact surface by knitting.

Furthermore, a material of the heat conducting member is graphene.

Furthermore, the shawl body includes a first portion and a second portion fixedly connected to the first portion; the first portion is configured to fit a shoulder and a back of the human body, and the second portion is configured to fit the neck of the human body.

Furthermore, the first portion includes a draping portion and two shoulder portions extending from the draping portion, the draping portion is configured to fit the back of the human body, the shoulder portions are configured to fit the shoulder of the human body, and the second portion is connected with the draping portions.

Furthermore, the second portion includes a bending portion, the second portion is connected with the first portion through the bending portion.

Furthermore, a counterweight structure is arranged at an outer edge of the first portion, the counterweight structure is disposed around an edge of the first portion, the counterweight structure includes a connection portion with a hollow center and a counterweight filled in the connection portion.

Furthermore, the first portion further includes a connection member configured to connect the two shoulder portions.

Furthermore, the connection member is a fastener, the fastener includes a male buckle and a female buckle, the male buckle and the female buckle are fastened together to connect the two shoulder portions.

Furthermore, the connection member is a magnetic member, the magnetic member includes an N pole and an S pole, and the N pole and the S pole are attracted together to connect the two shoulder portions.

Furthermore, the shawl body includes a first portion and a second portion, the shawl body further includes a power supply interface, the power supply interface is arranged on the first portion, the power supply interface is electrically connected to the heating element, and the power supply interface is configured to connect to an external power source to provide electrical energy to the heating element.

Furthermore, an outer edge of the first portion is provided with a counterweight structure, and the connection member is disposed on the counterweight structure.

Furthermore, the connection portion is detachably connected to the shawl body; or the connection portion is integrally molded with the shawl body.

Furthermore, the connection portion is detachably connected with the shawl body through a button connection or a zipper connection.

Furthermore, the counterweight is in a form of spherical particles or strips; or the counterweight is a far infrared magnet; or the counterweight has thermal conductivity.

Furthermore, the heating shawl further includes a plurality of counterweights, the counterweights fills an interior of the shawl body, a plurality of storage compartments are sewn on the shawl body through sewing, and the plurality of counterweights are evenly distributed in the storage compartments.

Furthermore, the heating element is a resistance wire that can be bent arbitrarily; or the material of the contact surface is a plush material.

The beneficial effect of the present disclosure is as follows, at least one heat conducting member is connected on the contact surface of a heating shawl, hereby the heat can be better transferred to a human body, enhancing the heating effect, and providing better use experience for the users.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of the three-dimensional structure according to the present disclosure in an unfolded state.

FIG. 2 is a schematic diagram of the three-dimensional structure according to the present disclosure in a buckled state.

FIG. 3 is a cross-sectional view along line C in FIG. 1.

FIG. 4 is an enlarged schematic view of part A of FIG. 3 according to the present disclosure.

FIG. 5 is an enlarged schematic view of part B of FIG. 3 according to the present disclosure.

FIG. 6 is a schematic diagram of the three-dimensional structure of an embodiment 2 according to the present disclosure.

FIG. 7 is a cross-sectional view of the embodiment 2 according to the present disclosure.

FIG. 8 is an enlarged schematic view of part D of FIG. 7 according to the present disclosure.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

### Embodiment 1

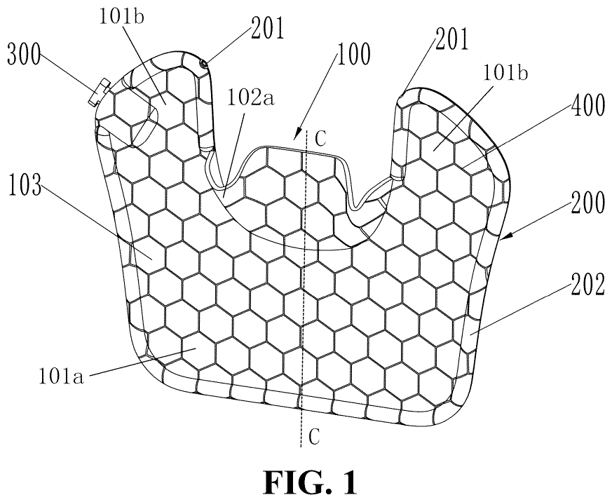

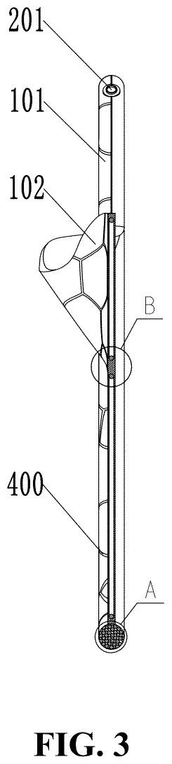

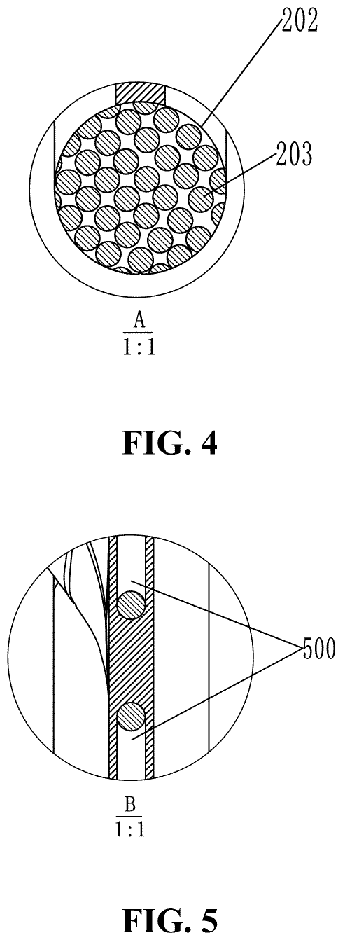

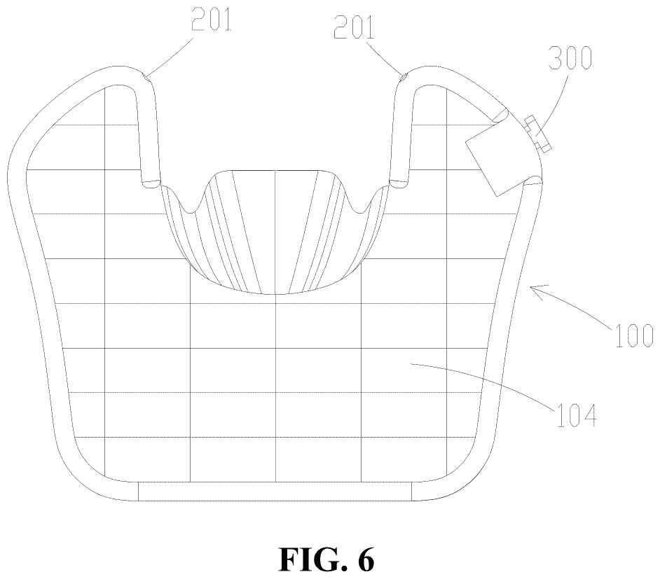

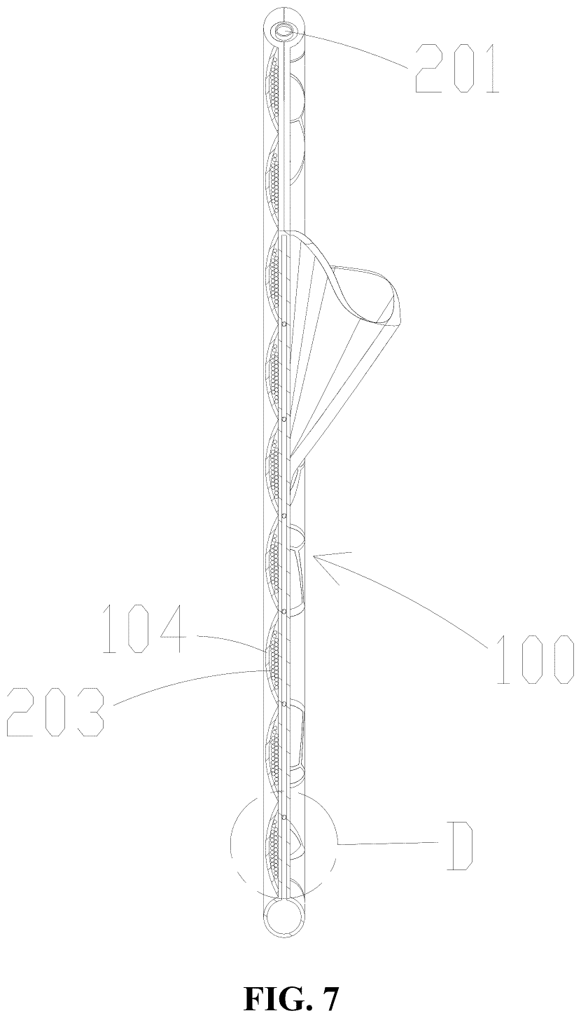

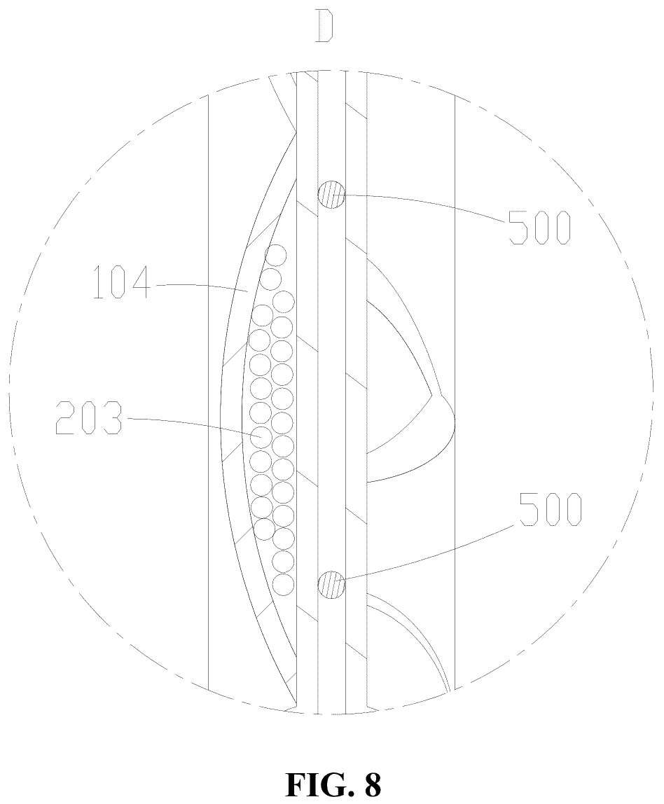

Referring to FIG. 1 to FIG. 5, the present disclosure provides a heating shawl, the heating shawl includes a shawl body 100 and a heating element 500 arranged inside the shawl body 100 and configured to heat the shawl body 100. The shawl body 100 includes a first portion 101 and a second portion 102. An outer side surface of the first portion 101 and the second portion 102 opposite to the heating element 500 is provided with a contact surface 103, the contact surface 103 is configured to contact with a human body. The contact surface 103 is connected to at least one heat conducting member for conducting heat, the heat from the heating element 500 can be better transmitted to the human body through the heat conducting member, avoiding heat loss.

In this embodiment, the heat conducting member includes at least one heat conducting strip 400, the number of the at least one heat conducting strip is a plurality, at least a portion of the heat conducting strips 400 are crossed with each other to form a heat conducting mesh. Some or all of the plurality of the heat conducting strips 400 can be cross-connected to form the heat conducting mesh. Configuration of the heat conducting mesh makes the heat from the heating element 500 transmitted to the human body more evenly, thereby increasing the comfort of the human body and the effect of the heat compress. A counterweight structure 200 is arranged at an outer edge of the first portion 101. The counterweight structure 200 includes a connection portion 202 with a hollow center, and a counterweight 203 filled in the connection portion 202. The counterweight structure 200 causes an edge of the first portion 101 drooped further downward under the gravity, ensuring that the contact surface 103 can fit closely to the human body, increasing the heat compress effect of the heating shawl.

In this embodiment, the shawl body 100 includes the first portion 101 and the second portion 102. The first portion 101 is configured to fit the shoulder and the back of the human body, the second portion 102 is configured to fit the neck of the human body. The first portion 101 and the second portion 102 are connected by stitching. The second portion 102 includes a bending portion 102a, the second portion 102 is connected with the first portion 101 through the bending portion 102a. The first portion 101 and the second portion 102 can be bent relative to each other through the bending portion 102a. When the users use the heating shawl, the user's head and neck often move, the design that the first portion 101 and the second portion 102 can be bent relative to each other, which can facilitate the second portion 102 following the movement of the user's neck, thereby the second portion 102 can better fit the user's neck. Specifically, the first portion 101 includes a draping portion 101a and two shoulder portions 101b extending from the draping portion 101a. When the users use the heating shawl, the draping portion 101a is configured to fit the user's back and shoulders, the shoulder portions 101b are configured to fit the user's shoulder in front of the user, balancing counterweights of the front and back of the heated shawl, whereby the heated shawl is not easy to fall off.

Furthermore, in an embodiment, the first portion 101 further includes a connection member 201, the connection member 201 includes a male buckle and a female buckle, the male buckle and the female buckle are fastened together to connect the two shoulder portions 101b. The male buckle includes a convex portion, and a corresponding groove or hole provided on the female buckle. The connection between the male buckle and the female buckle is realized by simply aligning the male buckle with the groove or hole of the female buckle and pressing, similarly, when the connection needs to be released, pulling them apart. Once fastened, the connection member 201 fixes the heating shawl to the user's shoulders, ensuring that the heating shawl will not loosen or fall off, and maintain a certain temperature.

In this embodiment, the counterweight structure 200 is arranged at the outer edge of the first portion 101. The connection member 201 is disposed on the counterweight structure 200. The connection member 201 is disposed on the counterweight structure 200 at a corresponding position of the shoulder portions 101b, thereby the connection member 201 is easily connected with the two shoulder portions 101b under the gravity of the counterweight structure 200.

In another embodiment of the connection member 201 (not shown in the figures), the connection member 201 further includes two magnets, each of the magnets is circular or rectangular (the specific shapes are varied). The two magnets are respectively embedded in an edge position of the adjacent sides of the two shoulder portions 101b, with a moderate size, to provide a stable adsorption force. In terms of position, an N pole of one magnet faces an S pole of another magnet. When the two magnets are gently approached by each other, they can automatically and quickly complete the adsorption. This non-contact connection avoids physical wear and tear caused by frequent fastening and unfastening, extending the service life of the connection member 201. In addition, the connection of the two magnets does not generate noise.

In another embodiment of the connection member 201 (not shown in the figures), the connection member 201 further is a Velcro, with a fiber surface and a bristle surface. The fiber surface is provided on a surface of one of shoulder portions 101b, the bristle surface is provided on an opposite surface of another shoulder portion 101b. The fiber surface and the bristle surface are fastened to achieve the connection of the two shoulder portions 101b. The connection of Velcro is simple and quick, has good wear resistance and durability, and can withstand multiple pulling and peeling without damage. The connection position of the fiber surface and the bristle surface can be adjusted to meet different usage needs.

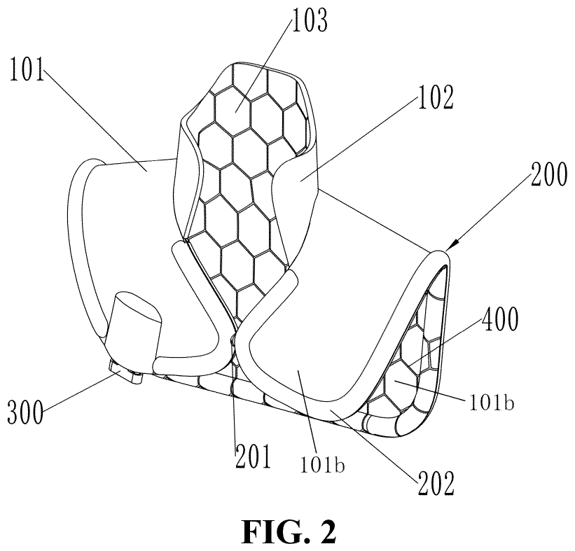

Referring to FIG. 2 to FIG. 5, in this embodiment, the heating element 500 is arranged inside the shawl body 100. The heating element 500 is a resistance wire that can be bent arbitrarily, the heating element 500 can heat continuously and stably, to maintain a stable temperature of the shawl body 100. The first portion 101 is provided with a power supply interface 300, the heating element 500 and the power supply interface 300 are electrically connected. The power supply interface is arranged at an easily accessible position on the first portion 101, whereby the user can charge the device at any time during use, thereby ensuring the continuous use of the heating shawl.

In another embodiment (not shown in the figure), a heat channel is arranged in the shawl body 100, the heat channel is evenly laid in the shawl body 100. The heat channel includes a hollow structure, accommodating a heat conductive glue to achieve a heating function. A glue inlet is provided on a left side of the first portion 101, and a glue outlet is provided on a right side of the first portion 101, thereby the heat conductive glue driving circular flow, and continuously passing through the heat channel, to maintain a suitable temperature of the heating shawl.

Referring to FIG. 1 to FIG. 2, in this embodiment, the shawl body 100 includes the first portion 101 and the second portion 102, the first portion 101 and the second portion 102 are an integrated structure, which have a natural transition to fit the human body contour. The first portion 101 is wider, which can cover and wrap the entire shoulder of the user, while the second portion 102 is slender, which can surround the neck of the user to provide warmth.

In this embodiment, both sides of the first portion 101 and the second portion 102 that directly contacts the human body is the contact surface 103. The material of the contact surface 103 is plush material, the fibers of the plush material are dense and fluffy, which can form an air layer to effectively isolate the cold outside, at the same time, the plush material has good elasticity and adaptability, making the heating shawl to fit the human body curves, reducing air convection, enhancing the heating effect.

In this embodiment, the heat conducting strips 400 is printed on the contact surface 103. A printing plate is provided with the same printing pattern identical to the heat conducting mesh. The heat-conducting material making the heat conducting strips 400 is brushed on the printing pattern, then the printing plate is pressed onto the contact surface 103, the heat conducting mesh is directly printed on the contact surface 103, thereby making the production process of the heat conducting mesh more convenient and quicker, and making the heat-conducting material more evenly distributed. In some embodiments, the heat conducting strips 400 further are connected to the contact surface 103 by sewing or pasting.

In another embodiment (not shown in the figure), the materials of the contact surfaces 103 on the first portion 101 and the second portion 102 are a faux cashmere, a polar fleece, and a microfiber. The faux cashmere is smooth, soft and elastic, colorful, low in cost, easy to care for, and provides a comfortable touch. The polar fleece is lighter, and has strong warmth retention, soft texture and good breathability and perspiration wicking ability. The microfiber has excellent softness and warmth retention, can quickly absorb and emit moisture to keep the skin dry, and is resistant to wear and wrinkles.

Referring to FIG. 2 to FIG. 4. In this embodiment, the heating shawl further includes a counterweight structure 200. The counterweight structure 200 includes a connection portion 202 with a hollow center, and a counterweight 203 filled in the connection portion 202.

By providing the counterweight structure 200, when the user uses the heating shawl, the counterweight structure 200 causes the edge of the first portion 101 drooped further downward under the gravity, thereby ensuring that the contact surface 103 can fit closely to the human body, increasing the heat compress effect of the heating shawl.

In this embodiment, the connection portion 202 is integrally molded with the shawl body 101, making the heating shawl structure more compact. Furthermore, a plurality of the heat conducting strips 400 cross to form a heat conducting mesh covering on the contact surface 103, which not only improves the heat conduction efficiency, but further makes the heat distribution more uniform.

Furthermore, in this embodiment, a material of the heat conducting strips 400 is a graphene. The graphene is a nanomaterial with strong thermal properties and high stability. The heat conducting mesh is circular, triangular, rectangular, and polygonal, in addition to being hexagonal. The heat conducting mesh makes the heat energy transmitted quickly and evenly distributed on the contact surface 103, ensuring the shoulder and neck areas of the user's body can contact the heated shawl, the user can feel balanced heat energy conduction. With the heat conducting mesh of different shapes, the heat conducting strips 400 have different heat conducting densities, whereby the heating shawl with different heat conducting densities is suitable for different groups of people and meets the needs of different groups of people.

In some embodiments, the heat conducting member is made of yarns, the yarns are knitted on the contact surface 103 during the production phase, to distribute the heat-conducting material, which is more conducive to uniform heat conduction.

In another embodiment (not shown in the figures), the heat conducting member on the contact surface 103 is a heat conducting spacer made of a carbon fiber. The carbon fiber has good thermal conductivity, the heat conducting spacer made of the carbon fiber can conduct heat. The heat is quickly and evenly distributed to all parts of the heating shawl with high thermal conductivity. While the carbon fiber has the characteristics of low density and high strength, thereby the heat conducting spacer made of the carbon fiber has good mechanical strength and durability while remaining lightweight. In addition, the carbon fiber heat conducting spacer has a certain degree of flexibility, which not only can improve the contact area of the heat conducting surface and the efficiency of thermal conductivity, but also can make the heating shawl fit with the human body when wearing, enhancing the comfort and warmth effect.

In another embodiment (not shown in the figures), a plurality of heat conducting strips 400 on the contact surface 103 are arranged at intervals. Furthermore, the plurality of the heat conducting strips 400 are not intersecting among each other, the plurality of heat conducting strips 400 are arranged evenly at intervals, which allows the heat to be evenly conducted to every portion of the shawl body, increasing the efficiency of thermal conductivity, and enhancing the comfort of the human body and the effect of the hot compress.

In this embodiment, the heat conducting strips 400 extend to the connection portion 202, one portion of the plurality of heat conducting strips 400 are cross connected to form a heat conducting mesh, another portion of the plurality of heat conducting strips 400 extend to an edge of the connection portion 202, thereby the connection portion 202 can transmit heat evenly.

In this embodiment, the counterweight 203 is a far infrared magnet and is placed into the hollow connection portion 202. When the heat conducting strips 400 transmit heat to the connection portion 202, the far infrared magnet is heated and generates far-infrared rays. The far-infrared rays have a deep penetration power, which can deep into the muscles and joints, thereby the heating shawl can improve joint pain and relieve muscle fatigue. The far-infrared rays can further penetrate deep into the human body, directly act on the painful area, promote local blood circulation, accelerate the absorption and dissipation of inflammatory exudates, and relieve pain.

In another embodiment (not shown in the figures), the counterweight 203 may be mineral sands (quartz sand) or mineral stones (volcanic rocks), these particulate matters are in circular or irregular shapes and evenly distributed in the connection portion 202 of the heating shawl. These counterweights are fixed in the counterweight structure of the shawl through a specific process to form a counterweight layer. The mineral sand or the mineral stone not only has high density, but also has certain thermal insulation properties, which can assist the heating effect.

In another embodiment (not shown in the figures), the shawl body 100 and the connection portion 202 are detachably connected, the shawl body 100 and the connection portion 202 are detachably connected by a snap button structure or a zipper structure. Both structures have connection stability, therefore the heating shawl doesn't fall off when worn on the human body. The detachable connection between the connection portion 202 and the shawl body 100 improves the flexibility of use, facilitates assembly and detachably, saving space and convenience for storage.

In one of the above embodiments (not shown in the figures), the shawl body 100 and the connection portion 202 are connected through a magnetic buckle. The magnetic buckle with the suction force of the magnet fastens between the connection portion 202 and the shawl body 100 together. The magnetic buckle pattern is fast and convenient and does not damage the material of the heating shawl. The magnetic buckle relies on magnetic force to avoid damage caused by mechanical wear and tears. This makes the service life of the magnetic buckle longer and more stable and reliable during use.

In one of the above embodiments (not shown in the figure), the shawl body 100 and the connection portion 202 are connected through a Velcro. The Velcro, also known as hook and loop fasteners or sticky tapes, consists of a hook surface with fine, soft fiber fluff on one side, and a fleece surface with stiff, fine plastic on another side. When using, press the hook surface and the fleece surface lightly to stick them together. Which is easy and quick to combine and separate, and is reused many times.

In summary, the present disclosure, by connecting the heat conducting member to the contact surface 103, the heat conducting member includes at a least one heat conducting strip 400, thereby the surface of the heating shawl can evenly distribute heat, enhancing the heating effect of the shawl, promoting blood circulation, and effectively relieving muscle fatigue and soreness.

### Embodiment 2

The present disclosure provides a heating shawl, including a shawl body 100 and a heating element 500 arranged inside the shawl body 100 and configured to heat the shawl body 500. The shawl body 100 includes a first portion 101 and a second portion 102. An outer side surface of the first portion 101 and the second portion 102 opposite to the heating element 500 includes a contact surface 103 configured to contact with a human body. The contact surface 103 is provided with at least one heat conducting member for conducting heat, the heat conducting member includes at least one heat conducting strip 400, the number of the heat conducting strips 400 is a plurality. At least a portion of the heat conducting strips 400 are crossed with each other to form a heat conducting mesh for evenly dispersing heat. The shawl body 100 includes a plurality of counterweights 203, the counterweights 203 make the contact surface 103 fitting the human body under the gravity.

The difference between the embodiment 2 and the embodiment 1 is as follows (not shown in the figures). The counterweights 203 may be spherical particles, a plurality of storage compartments 104 are sewn on the shawl body 100. When sewing, some of the counterweights 203 are placed in the storage compartments 104, the counterweights 203 are evenly distributed in the storage compartments 104, whereby the counterweights of the shawl body 100 are more evenly distributed. By this way, the shawl body 100 has a weight-bearing effect, ensuring that the contact surface 103 of the first portion 101 and the second portion 102 is contacted with the human body, improving the heat compress effect.

In this embodiment, to ensure that an edge of the first portion 101 is closely contacted with the human body, a strap (not shown in the figures) is provided at the hem position of the first portion 101, the shawl body 100 is tied to the human body through the strap. In this way, the shawl body 100 is prevented from shaking during the user's movement, and the contact surface 103 of the shawl body 100 is closely contacted with the human body.

1. A heating shawl, comprising:
a shawl body; and
a heating element, arranged inside the shawl body and configured to heat the shawl body;
wherein an outer side surface of the shawl body opposite to the heating element comprises a contact surface configured to contact with a human body;
at least one heat conducting member is connected to the contact surface and configured to conduct heat from the heating element to the human body; wherein the heat conducting member comprises a plurality of heat conducting strips, at least a portion of the heat conducting strips are crossed with each other to form a heat conducting mesh to spread the heat evenly, a shape of the heat conducting mesh is hexagonal;
wherein the shawl body comprises two should portions and a connection member configured to connect the two shoulder portions by magnetic attraction;
wherein the shawl body is provided therein with a counterweight, the counterweight is mineral sands or mineral stones.

2. (canceled)

3. (canceled)

4. The heating shawl according to claim 1, wherein the heat conducting member is printed on the contact surface.

5. The heating shawl according to claim 1, wherein the heat conducting member is yarn, connecting to the contact surface by knitting.

6. The heating shawl according to claim 1, wherein a material of the heat conducting member is graphene.

7. The heating shawl according to claim 1, wherein the shawl body comprises a first portion and a second portion fixedly connected to the first portion; the first portion is configured to fit a shoulder and a back of the human body, and the second portion is configured to fit a neck of the human body.

8. The heating shawl according to claim 7, wherein the first portion comprises a draping portion and the two shoulder portions extending from the draping portion, the draping portion is configured to fit the back of the human body, the shoulder portions are configured to fit the shoulder of the human body, and the second portion is connected with the draping portions.

9. The heating shawl according to claim 7, wherein the second portion comprises a bending portion, the second portion is connected with the first portion through the bending portion.

10. The heating shawl according to claim 7, wherein a counterweight structure is arranged at an outer edge of the first portion, the counterweight structure is disposed around an edge of the first portion, the counterweight structure comprises a connection portion with a hollow center and the counterweight filled in the connection portion.

11. (canceled)

12. (canceled)

13. (canceled)

14. The heating shawl according to claim 1, wherein the shawl body comprises a first portion and a second portion, the shawl body further comprises a power supply interface, the power supply interface is arranged on the first portion, the power supply interface is electrically connected to the heating element, and the power supply interface is configured to connect to an external power source to provide electrical energy to the heating element.

15. The heating shawl according to claim 11, wherein an outer edge of the first portion is provided with a counterweight structure, and the connection member is disposed on the counterweight structure.

16. The heating shawl according to claim 10, wherein the connection portion is detachably connected to the shawl body; or the connection portion is integrally molded with the shawl body.

17. The heating shawl according to claim 10, wherein the connection portion is detachably connected with the shawl body through a button connection or a zipper connection.

18. The heating shawl according to claim 10, wherein the counterweight is in a form of spherical particles or strips.

19. The heating shawl according to claim 1, wherein the heating shawl further comprises a plurality of counterweights, the counterweights fills an interior of the shawl body, a plurality of storage compartments are sewn on the shawl body through sewing, and the plurality of counterweights are evenly distributed in the storage compartments.

20. The heating shawl according to claim 1, wherein the heating element is a resistance wire that can be bent arbitrarily; or the material of the contact surface is a plush material.
